(19) United States
(12) Patent Application Publication
(10) Pub. No.: US 2008/0104265 A1
(43) Pub. Date: May 1, 2008

(54) Method and System For String Preferences Extension For Media Transfer Protocol

(76) Inventor: Scott Krig, Santa Clara, CA (US)

Correspondence Address: MCANDREWS HELD & MALLOY, LTD, 500 WEST MADISON STREET, SUITE 3400, CHICAGO, IL, 60661, US

(21) Appl. No.: 11/741,073

(22) Filed: Apr. 27, 2007

Related U.S. Application Data
(60) Provisional application No. 60/863,206, filed on Oct. 27, 2006.

(51) Int. Cl. G06F 15/16

(52) U.S. Cl. 709/230

(57) ABSTRACT

In a method and system for indicating a string preferences extension for the media transfer protocol (MTP), a preferred string format for string transfers to and/or from a device that communicates via said MTP may be specified in one or more extensions of the MTP. The preferred string format for the string transfers may be indicated as a device property within the extensions of the MTP. The preferred string format for the string transfers may be indicated using a field within a DeviceInfo Dataset of the MTP extensions. The device may communicate the preferred string format to another device upon initiation of communication or in response to a request such as a GetDeviceInfo operation. The response may comprise an MTP DeviceInfo dataset. A default string format may be specified as one of said MTP extensions. A string format that differs from the preferred string format may be selected for string transfers.

### CROSS-REFERENCE TO RELATED APPLICATIONS/INCORPORATION BY REFERENCE

This application makes reference to, claims priority to, and claims the benefit of U.S. Provisional Application Ser. No. 60/863,206, filed on Oct. 27, 2006, entitled “METHOD AND SYSTEM FOR DEVICE PREFERENCES EXTENSION FOR MEDIA TRANSFER PROTOCOL,” which is incorporated herein by reference in its entirety.

### FIELD OF THE INVENTION

Certain embodiments of the invention relate to multimedia communication. More specifically, certain embodiments of the invention relate to a method and system for a string preferences extension for the media transfer protocol (MTP).

### BACKGROUND OF THE INVENTION

The media transfer protocol (MTP) is an extension of the industry standard picture transfer protocol (PTP). The media transfer protocol was created as an extension to the picture transfer protocol specifically for media devices and includes various provisions for digital rights management (DRM).

Digital rights management (DRM) and electronic license management technologies may be utilized for home video, music, consumer and enterprise software markets. Motion picture studios, cable and satellite TV operators, consumer electronics companies and personal computer manufacturers use DRM technologies to prevent the unauthorized duplication, reception or use of copyrighted video materials.

PIMA 15740:2000 provides a common communication mechanism for exchanging images with and between digital still photography devices (DSPDs). This includes communication between digital still photography devices and host computers, printers, other digital still devices, telecommunications kiosks, and image storage and display devices. This standard presents a protocol that is intended to be transport and platform independent. The purpose of this intent is to enable standard behavior by allowing implementation of the protocol in a variety of standard transports. Exemplary transports include USB (Universal Serial Bus), IEEE 1394, and IrDA (Infrared Data Association). This standard specifies the following:

Behavior requirements for DSPDs include: baseline features a device needs to support to provide interoperability over conforming transports; functional requirements needed by a transport to enable the creation of a transport-dependent implementation specification that conforms to this standard; and a high-level protocol for communicating with and between DSPDs consisting of operation, data, and response phases.

Currently, the MTP spec allows for digital rights management licenses and certificates to be sent and received using Unicode UTF-16 format. The UTF-16 format is not optimal for transmission in all cases, and forces devices to implement software to translate between UTF-16 and other formats such as UTF-32, ASCII, for example. The Unicode translation process consumes CPU time, which slows down the performance of the device for the customer. For a portable device, storage space is often at a premium. UTF-16 occupies double the storage space compared to ASCII, and also requires additional program code for string translation which occupies program memory. The String translation process consumes CPU time and power which slows down the performance of the device for the customer and adds to the cost of the device. The required storage and memory may also increase device size. In other words, the Unicode translation is an added burden to many devices due to the specification of the MTP.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for a string preferences extension for the media transfer protocol, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system comprising a plurality of devices which are communicatively coupled and utilize at least one extension of the MTP protocol to indicate a preferred string format, in accordance with an embodiment of the invention.

FIG. 2 is a flow chart illustrating exemplary steps utilizing DeviceInfo Dataset to indicate preferred string format for MTP string transfers, in accordance with an embodiment of the invention.

FIG. 3 is a flow chart illustrating exemplary steps utilizing Device Properties to indicate the preferred string format for MTP string transfers, in accordance with an embodiment of the invention.

FIG. 4 is a flow chart illustrating exemplary steps utilizing Device Properties to indicate a preferred string format for MTP string transfers, in accordance with an embodiment of the invention.

### DETAILED DESCRIPTION OF THE INVENTION

Certain aspects of the invention may be found in a method and system for a string preferences extension for the media transfer protocol (MTP). Aspects of the method and system may comprise indicating a preferred string format within one or more extensions of the MTP, and enabling devices to indicate the preferred string format for string transfers between devices utilizing the MTP. The preferred string format for the string transfers may be indicated as a device property within the extensions of the MTP. The preferred string format for the string transfers may be indicated using a field within a DeviceInfo Dataset of the MTP extensions. The device may communicate the preferred string format to another device upon initiation of communication or in response to a request such as a GetDeviceInfo operation. The response may comprise an MTP DeviceInfo dataset. A default string format may be specified as one of said MTP extensions. A string format that differs from the preferred string format may be selected for string transfers.

One aspect of the invention may comprise adding an indicator of the preferred string format as a device property within one or more extensions of the MTP. The indicator of the preferred string format may be added by defining a new field for DeviceInfo Dataset within the one or more extensions of the MTP. The preferred string format may apply to any string transmitted or received via MTP which may include for example: Data Rights Management (DRM) licenses, parameters in operation, event and response parameters and fields in datasets. Utilizing the indicator of the preferred string format within one or more extensions of the MTP may improve performance metrics such as storage allocation, CPU time and power requirements by enabling the string transfers in a format that is native to a device. Exemplary string formats may comprise UTF-32, UTF-8 and ASCII.

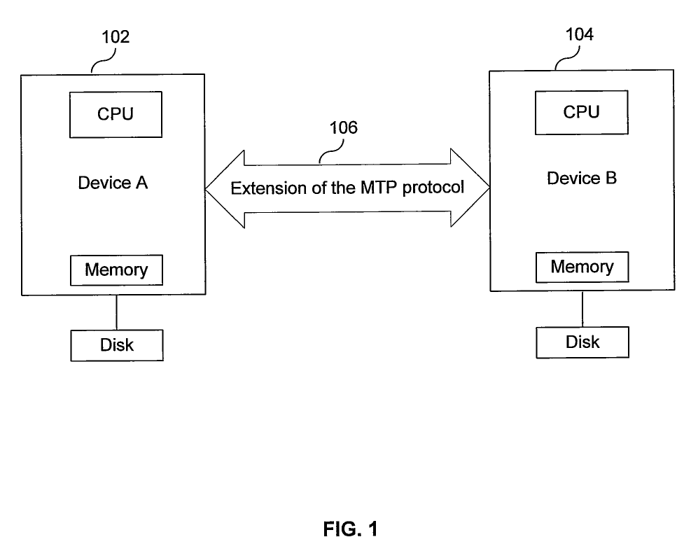

FIG. 1 is a block diagram of an exemplary system comprising a plurality of devices which are communicatively coupled and utilize one or more extension of the MTP to indicate the preferred string format, in accordance with an embodiment of the invention. Referring to FIG. 1 there is shown one or more extensions of the MTP (106) that facilitates communication between a device 102 and a device 104.

The system illustrated in FIG. 1, enables a method for transferring string format preferences via Media Transfer Protocol (MTP) wherein, the preferred string format for string transfers to and from device 102, which may be a host computer, and device 104 which may be a hand-held device, may be indicated within one or more extension of the MTP 106.

The string preferences extention of the MTP 106 enables the device 104 to communicate string preferences capability or to indicate its string format preference to the device 102. The string preferences extension of the MTP 106 may for example add a device property to the existing MTP for indicating the preferred string format. In another embodiment of the invention, the string preferences extension 106 of the MTP may utilize DeviceInfo dataset to communicate the string preferences information. For example, new parameters may be defined for existing fields within DeviceInfo dataset or a new field may be added for indicating the preferred string format.

The device 102 may comprise suitable logic, circuitry and/or code that may enable transfer of information to and from the device 104 via MTP and at least one extension of the MTP 106. In one embodiment of the invention, the device 102 may be a host computer referred to in MTP specifications as an initiator, and that may handle the string transfers while exchanging for example, media content and messages with the device 104.

The device 104 may comprise suitable logic, circuitry, and/or code that may enable the transfer of information to and from the device 102 via the MTP and at least one extension of the MTP. In one embodiment of the invention, the device 104 may be a hand-held device referred to in the MTP specification as a responder, and that may handle the string transfers while exchanging for example: media content and messages with the device 102.

The extension of the MTP 106 may comprise modified specifications within the MTP architecture. An indicator of the preferred string format may be established by adding to the Device Properties specification, a new device property description which may be named, for example, String Preferences Property and may appear in the MTP specification as shown in Table 1. The String Preferences Property is the device property that specifies the String or Unicode format used for MTP string transfers.

TABLE 1
String Preferences Property

| | Field | Size | Data | |
|---|---|---|---|---|
| Field name | order | (bytes) | Type | Value |
| PropertyCode | 1 | 2 | UINT16 | 0xDD73 (for example) |
| Datatype | 2 | 2 | UINT16 | 0xFFFF (STRING) |
| Get/Set | 3 | 1 | UINT8 | 0x01 (GET/SET) |
| DefaultValue | 4 | | | 0x00 (default: UTF-16) |
| GroupCode | 5 | 4 | UINT32 | Device-defined |
| FormFlag | 6 | 1 | UINT8 | 0x00 None |

The following exemplary values may be allowed: ASCII, UTF-8, UTF-16 and UTF-32 or other suitable values. In an exemplary embodiment of the invention, UTF-16 may be designated as a default value and may be represented as 0×00. The String Preferences Property may apply to any strings transferred via MTP and may comprise: DRM licenses; parameters in operation, event and response parameters; and/or fields in datasets. Using the String Preferences Property allows a portable device to reduce the string translation burdens on storage, processing, and power requirements and unify string handling in preferred native formats such as UTF-32, UTF-8 or ASCII.

In another embodiment of the invention, an extension of the MTP 106 may comprise establishing an indicator of the preferred string format by adding to the DeviceInfo dataset specification, a new dataset field which may be named, for example, String Format. In an alternative embodiment of the invention, new parameters within existing fields in the DeviceinfoDataset may be used to indicate string preferences information. As shown in Table 2, there are several ways which the DeviceinfoDataset field may be used to communicate the string preferences information including a new field such as the last dataset field named “string format,” which has field order 15, size of 2 bytes and has a datatype of unsigned integer of 16 bits.

Or alternatively, existing fields in the DeviceinfoDataset could be used to indicate string preferences. As shown in Table 2, there are several ways which the DeviceinfoDataset field could be used to indicate the string preferences using existing fields and by adding new fields such as the last dataset field named “string format”.

The DeviceInfo dataset may be used to provide a description of the device. This DeviceInfo dataset may be obtained using the GetDeviceInfo operation without first initiating a session, and is mostly static. In instances where any value in this DeviceInfo dataset is changed within a session, a DeviceInfoChanged event may be issued to each connected device, and each connected device may re-acquire the DeviceInfo dataset to determine the updated values.

The DeviceInfo dataset may change within a session, for example, in response to a change in the Functional Mode of the device. A device may enter a “sleep” state where it has a limited (but sufficient) set of enabled MTP operations and functionality. In instances where such a state may be entered, a DeviceInfoChanged event may be issued to each active session to alert them to the changed functionality of the device.

TABLE 2

| | Field | Size | |
|---|---|---|---|
| Dataset field | order | (bytes) | Datatype |
| Standard Version | 1 | 2 | UINT16 (a new parameter |
| | | | may indicate string |
| | | | preferences) |
| MTP Vendor Extension | 2 | 4 | UINT32 (a new parameter |
| ID | | | may indicate string |
| | | | preferences) |
| MTP Version | 3 | 2 | UINT16 (a new parameter |
| | | | may indicate string |
| | | | preferences) |
| MTP Extensions | 4 | Variable | String |
| Functional Mode | 5 | 2 | UINT16 (a new parameter |
| | | | may indicate string |
| | | | preferences) |
| Operations Supported | 6 | Variable | Operation Code Array |
| Events Supported | 7 | Variable | Event Code Array |
| Device Properties | 8 | Variable | Device Property Code |
| Supported | | | Array (a new parameter |
| | | | may indicate string |
| | | | preferences) |
| Capture Formats | 9 | Variable | Object Format Code Array |
| Playback Formats | 10 | Variable | Object Format Code Array |
| Manufacturer | 11 | Variable | String |
| Model | 12 | Variable | String |
| Device Version | 13 | Variable | String |
| Serial Number | 14 | Variable | String |
| String Format (a new | 15 | 2 | UINT16 |
| field may indicate string | | | |
| preferences) | | | |

### Table 3 illustrates exemplary values that may be allowed for the String Format Datatype.

TABLE 3
String format

| Value | Meaning |
|---|---|
| 1 | “ASCII” |
| 2 | “UTF-8” |
| 3 | “UTF-16” (default) |
| 4 | “UTF-32” |
| n − 1 | Other string type |
| n | Other string type |

In an exemplary embodiment of the invention, a default value of 0×00 may be utilized to indicate UTF-16. The string Preferences Property may apply to any strings transferred via MTP comprising, DRM licenses; parameters in operation, event and response parameters, and fields in datasets, for example.

In operation, device 102 shown in FIG. 1 may be a host computer attempting to download media content to a device 104 utilizing the one or more extensions of the MTP 106. Prior to downloading the media content, the device 102 may query the device 104 to determine which string format is preferred by the device 104. In one embodiment of the invention, the device 102 may send a GetDeviceInfo operation request to the device 104 and the device 104 may respond with a block of information called DeviceInfo dataset that may contain new parameter settings for existing dataset fields indicating string preferences. In another embodiment of the invention, device 104 may respond to the GetDeviceInfo operation request with a dataset containing a new dataset field named String Format. The String Format setting may be indicated within a corresponding Datatype field parameter. In another embodiment of the invention, the device 102 may send a GetDevicePropDesc or a GetDevicePropValue operation request to the device 104. Respective to the operation that was sent: the device 104 may respond with the entire DevicePropDesc dataset for the String Preferences or just the current value of the string format setting from the DevicePropDesc dataset. The device 102 may then transmit and receive all string transfers to and from the device 104 utilizing the preferred string format. Since MTP Device Properties may be read-only or read-write, the device 102 may attempt to change to a new preferred string format value. In this regard, the device 102 may send a SetDevicePropValue operation request to the device 104. The device 104 may accept or reject the requested new string format value.

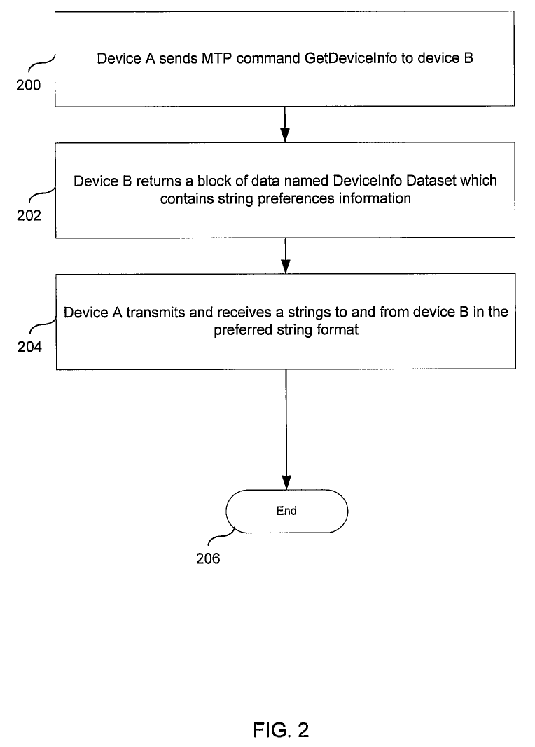

FIG. 2 is a flow chart illustrating exemplary steps utilizing DeviceInfo dataset to indicate a preferred string format for MTP string transfers, in accordance with an embodiment of the invention. Referring to FIG. 2, in step 200, device 102 sends an MTP GetDeviceInfo operation request to device 104. In step 202, device 104 responds with a block of data named DeviceInfo dataset which contains a new parameter to an existing Dataset Field or a new Dataset Field named String Format and indicates the preferred string format in the corresponding datatype field. In step 204, device 102 transmits and receives strings to and from device 104 according to the preferred sting format. The exemplary steps may end at step 206.

In an exemplary embodiment of the invention, it may be desirable for device 102 to communicate with device 104 of FIG. 1. Accordingly, device 102 may query device 104 in order to obtain device information for device 104. In this regard, device 102 may send the GetDeviceInfo operation request to device 104. The device 104 may respond with its DeviceInfo Dataset. The DeviceInfo dataset contains a new dataset field named string format, which indicates the preferred string format for device 104 in the corresponding datatype field. If for example, the datatype field indicates that the preferred format for device 104 is UTF-32, then device 102 and device 104 may communicate strings in UTF-32 format.

In accordance with an embodiment of the invention, if for example, an application of device 104 changes the preferred string format to UTF-16 during an open session, then device 104 may send a message to device 102 to indicate that a change has been made. Device 102 may then send a GetDeviceInfo operation request to device 104 to see what has changed in the DeviceInfo dataset.

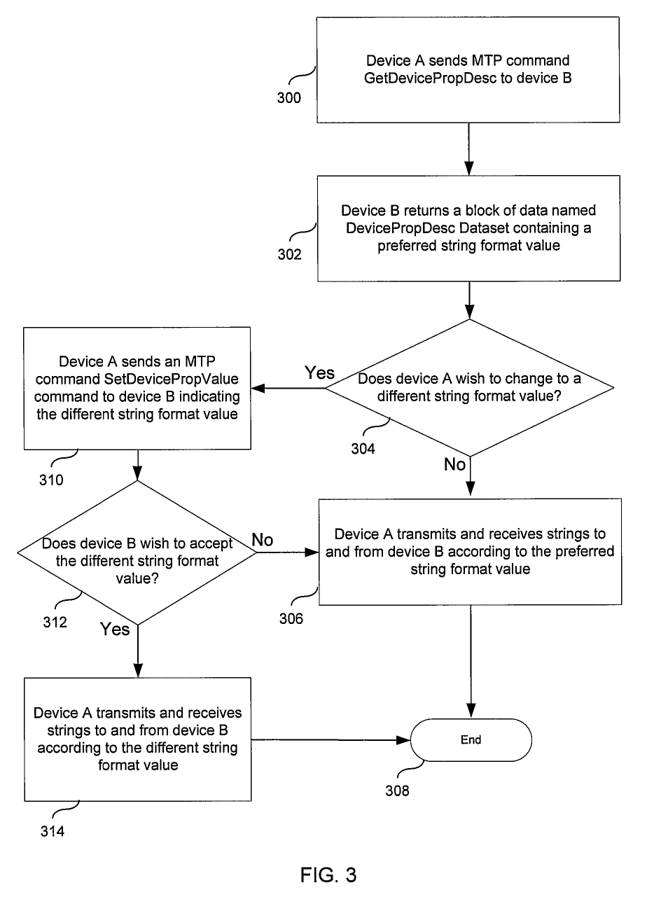

FIG. 3 is a flow chart illustrating exemplary steps utilizing the Device Properties to indicate a preferred string format for MTP string transfers, in accordance with an embodiment of the invention. Referring to FIG. 3, in step 300, the device 102 may send a GetDevicePropDesc operation request to the device 104. In step 302, the device 104 may return a block of data named DevicePropDesc containing the preferred string format value. In step 304, it may be determined whether device 102 wishes to change to a different string format. If device 102 does not wish to change to the different string format, then in step 306, the device 102 may transmit and receive strings to and from the device 104 according to the preferred string format value. If device 102 wishes to change to the different string format, in step 310, the device 102 may send a SetDevicePropValue operation request to the device 104 indicating the different string format value. In step 312, it may be determined whether the device 104 wishes to accept the different string format value. If the device 104 wishes to accept the different string format value, then in step 314, the device 102 may transmit and receive strings to and from the device 104 according to the different string format value. In step 312, if device 104 does not wish to accept the different string format value, then device 102 may transmit and receive strings in the preferred string format value. Subsequent to steps 306 and 314, control may pass to the end 308.

In accordance with an exemplary embodiment of the invention, the device 102 may send a GetDevicePropDesc operation request to a device 104. In response to the GetDevicePropDesc command, the device 104 may return a block of data named DevicePropDesc dataset containing a preferred string format value. If the device 102 does not wish to change the preferred string format value, the device 102 may transmit and receive strings using the preferred string format or a default string format. If the device 102 wishes to change the preferred string format value to a different string format value, the device 102 may send a SetDevicePropValue operation request to the device 104 containing the different string format value. The device 104 may then determine whether to accept the different string format value. If the device 104 decides to accept the different string format value, then the device 102 may communicate with the device 104 according to the different string format value. If the device 104 does not wish to accept the different string format value, the device 102 may communicate with the device 104 using the preferred string format value or the default string format value.

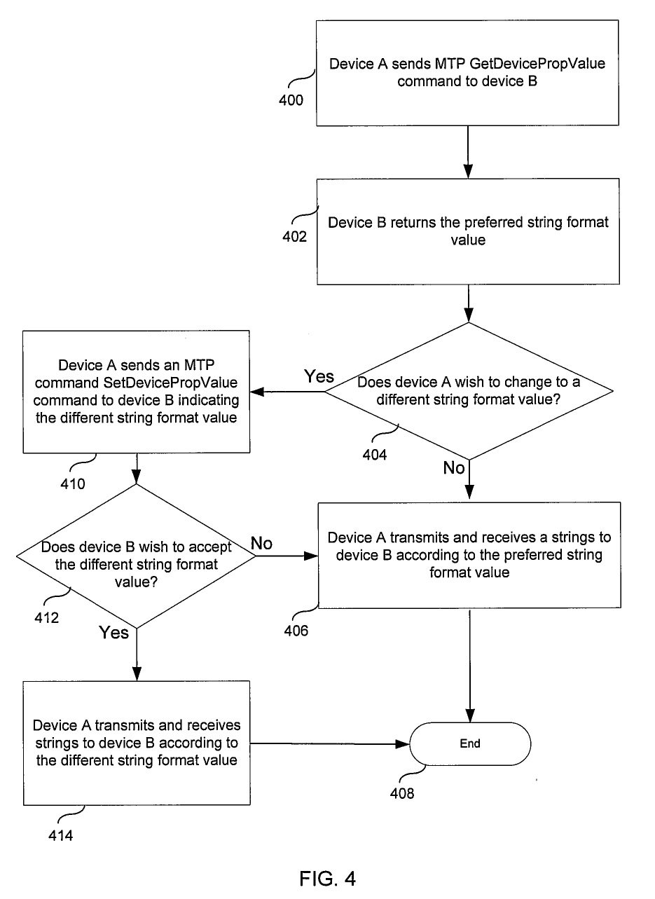

FIG. 4 is a flow chart illustrating exemplary steps utilizing Device Properties to indicate a preferred string format for MTP string transfers, in accordance with an embodiment of the invention. Referring to FIG. 4, in step 400, the device 102 may send an MTP GetDevicePropValue command to the device 104. In step 402, the device 104 returns just the preferred string format value. In step 404, it may be determined whether device 102 wishes to change to a different string format value. If device 102 does not wish to change to the different string format, then in step 406, the device 102 may transmit and receive strings to and from the device 104 according to the preferred string format value. If the device 102 wishes to change to the different string format, in step 410, the device 102 may send a SetDevicePropValue command to the device 104 indicating the different string format value. In step 412, it may be determined whether the device 104 wishes to accept the different string format value. If the device 104 wishes to accept the different string format value, then in step 414, the device 102 may transmit and receive strings to and from the device 104 according to the different string format value. In step 412, if device 104 does not wish to accept said the different string format value, then device 102 transmits and receives strings according to the preferred string format or a default string format. Subsequent to steps 306 and 314, control may pass to the end 308.

In a method and system for indicating a string preferences extension for media transfer protocol (MTP), a preferred string format for string transfers to and/or from a device 104 that communicates via the MTP, may be specified in one or more extensions of media transfer protocol (MTP) 106. The preferred string format for the device 104 string transfers may be indicated as a Device Property within the extensions of the MTP 106. The preferred string format for the string transfers may be indicated using a field within a DeviceInfo dataset of the MTP extensions 106. The device 104 may communicate the preferred string format to another device 102 upon initiation of communication or in response to an operation request such as a GetDeviceInfo operation. The response from device 104 may comprise an MTP DeviceInfo dataset. A default string format may be specified as one of the MTP extensions 106. A string format that differs from the preferred string format may be selected for the string transfers to and/or from the device 104. An event may be issued to indicate when changes to the specified string format occur.

Certain embodiments of the invention may comprise a machine-readable storage having stored thereon, a computer program having at least one code section for communicating information within a network, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for communicating multimedia information, the method comprising: specifying within one or more extensions of a media transfer protocol (MTP), a preferred string format for string transfers to and/or from a device that communicates via said MTP.

2. The method according to claim 1, comprising indicating said preferred string format for said string transfers as a string preferences device property within said one or more extensions of said MTP.

3. The method according to claim 1, comprising indicating said preferred string format for said string transfers using a field within a DeviceInfo Dataset of said one or more MTP extensions.

4. The method according to claim 1, wherein said device communicates said preferred string format to another device when said device initiates communication with said another device.

5. The method according to claim 1, comprising specifying said preferred string format in response to a request.

6. The method according to claim 5, wherein said request comprises a GetDeviceInfo operation.

7. The method according to claim 5, wherein said response comprises an MTP DeviceInfo dataset.

8. The method according to claim 5, wherein said request comprises a GetDevicePropDesc operation.

9. The method according to claim 5, wherein said response comprises MTP DevicePropDesc datasets.

10. The method according to claim 5, wherein said request comprises a GetDevicePropValue operation.

11. The method according to claim 5, wherein said response comprises an MTP DevicePropValue dataset.

12. The method according to claim 1, comprising specifying a default string format as one of said MTP extensions.

13. The method according to claim 1, comprising selecting a string format that differs from said preferred string format for said string transfers to and/or from said device.

14. The method according to claim 13, wherein said selecting comprises a SetDevicePropValue operation.

15. The method according to claim 13, wherein said device chooses to accept or reject said string format that differs.

16. The method according to claim 1, comprising issuing an event to indicate when changes to said specified string format occurs.

17. A system for communicating multimedia information, the system comprising: at least one processor in a device that specifies within one or more extensions of a media transfer protocol (MTP), a preferred string format for string transfers to and/or from said device that communicates via said MTP.

18. The system according to claim 17, wherein said at least one processor indicates said preferred string format for said string transfers as a string preferences device property within said one or more extensions of said MTP.

19. The system according to claim 17, wherein said at least one processor indicates said preferred string format for said string transfers using a field within a DeviceInfo Dataset of said one or more MTP extensions.

20. The system according to claim 17, wherein said at least one processor communicates said preferred string format to another device when said device initiates communication with said another device.

21. The system according to claim 17, wherein said at least one processor specifies said preferred string format in response to a request.

22. The system according to claim 21, wherein said request comprises a GetDeviceInfo operation.

23. The system according to claim 21, wherein said response comprises an MTP DeviceInfo dataset.

24. The system according to claim 21, wherein said request comprises a GetDevicePropDesc operation.

25. The system according to claim 21, wherein said response comprises MTP DevicePropDesc datasets.

26. The system according to claim 21, wherein said request comprises a GetDevicePropValue operation.

27. The system according to claim 21, wherein said response comprises an MTP DevicePropValue dataset.

28. The system according to claim 17, wherein said at least one processor specifies a default string format as one of said MTP extensions.

29. The system according to claim 17, wherein said at least one processor selects a string format that differs from said preferred string format for said string transfers to and/or from said device.

30. The system according to claim 29, wherein said selecting comprises a SetDevicePropValue operation.

31. The system according to claim 29, wherein said at least one processor determines whether to accept or reject said string format that differs.

32. The system according to claim 17, wherein said at least one processor issues an event to indicate when changes to said specified string format occurs.
